(19) United States
(12) Patent Application Publication
(10) Pub. No.: US 2009/0124264 A1
(43) Pub. Date: May 14, 2009

(54) METHOD AND MOBILE PHONE CAPABLE OF AUTOMATICALLY SWITCHING RADIO CHANNELS OF A FREQUENCY MODULATION RADIO

(75) Inventor: YI-JEN SU, Tu-Cheng (TW)

Correspondence Address: PCE INDUSTRY, INC.;ATT. Steven Reiss, 458 E. LAMBERT ROAD, FULLERTON, CA, 92835, US

(73) Assignee: CHI MEI COMMUNICATION SYSTEMS, INC., Tu-Cheng City (TW)

(21) Appl. No.: 12/189,130

(22) Filed: Aug. 8, 2008

(30) Foreign Application Priority Data
Nov. 9, 2007 (CN) 200710202437.3

(51) Int. Cl. H04Q 7/20; H04M 1/00

(52) U.S. Cl. 455/450; 455/552.1

(57) ABSTRACT

A mobile phone capable of switching radio channels of an FM radio is provided. The mobile phone includes antennas for receiving analog signals and wireless signals. The mobile phone includes a signal conversion module for converting the analog signals to digital signals, and a channel database for storing radio channel information corresponding to LAI information of different local areas. A communication protocol processing module of the mobile phone is configured for receiving the digital signals, and for reading the LAI information of a local area where the mobile phone is located. A FM management module of the mobile phone is configured for searching the channel database to retrieve available radio channel information in the local area, synchronously monitoring if the LAI information changes, and determining if the FM radio needs to switch from one radio channel to another radio channel.

### BACKGROUND

1. Field of the Invention

Embodiments of the present disclosure relate to systems and methods for management of mobile devices, and particularly to a method and mobile phone capable of automatically switching radio channels of a frequency modulation (FM) radio.

2. Description of Related Art

FIG. 1 illustrates different location areas covered by a global system for mobile communication (GSM) or a universal mobile phone service (UTMS) network. Usually, the GSM or UTMS network divides the broadcast service area into a plurality of location areas, such as LA1 and LA2 as shown in FIG. 1. Each location area has a plurality of base transceiver stations (BTS) for receiving and sending mobile signals. Mobile devices in the GSM or UTMS network continually receive information on location area sent by the BTS. As shown in FIG. 1, information on each location area in the GSM/UMTS network includes a unique location area identity (LAI).

Mobile phones may have FM radio capabilities to listen to one or more radio stations. Presently, users of the mobile phones need to manually search through all radio channels, in order to select radio stations available for listening to radio broadcast when they are currently located in a place. Such searching process may be burdensome and frustrating, particularly when the users travelers frequently.

What is needed, therefore, is a method and mobile phone capable of automatically switching radio channels of a FM radio, based on LAI information and radio channel information, so as to facilitate the user to listen to radio broadcast during traveling.

### SUMMARY

A mobile phone capable of switching radio channels of an FM radio is provided. The mobile phone comprises antennas for receiving analog signals and wireless signals. The FM radio is configured for playing radio broadcast according to the wireless signals. The mobile phone further comprises a signal conversion module for converting the analog signals to digital signals, and a channel database for storing radio channel information corresponding to LAI information of different local areas. The mobile phone further comprises a communication protocol processing module and an FM management module. The communication protocol processing module is configured for receiving the digital signals, and for reading the LAI information of a local area where the mobile phone is located. The FM management module is configured for searching the channel database to retrieve available radio channel information in the local area, synchronously monitoring if the LAI information changes, and determining if the FM radio needs to switch from one radio channel to another radio channel.

Other objects, advantages and novel features of the present invention will become more apparent from the following detailed description of certain embodiments of the present disclosure when taken in conjunction with the accompanying drawings, in which:

### BRIEF DESCRIPTION OF THE DRAWINGS

FIG. 1 illustrates location areas covered by a GSM/UTMS network;

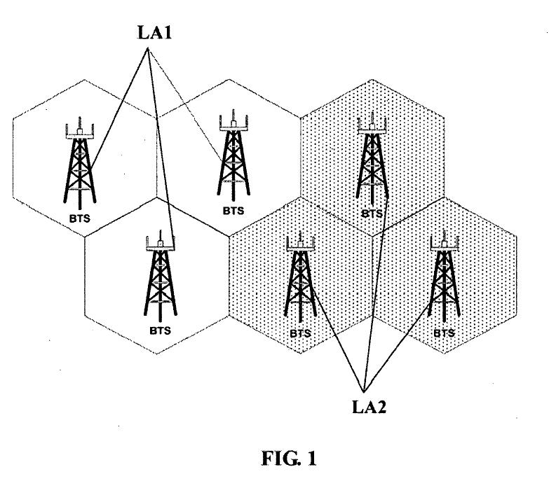

FIG. 2 is a functional block diagram of a mobile phone capable of automatically switching radio channels of a FM radio within the mobile phone in accordance with one embodiment; and

FIG. 3 is a flowchart of a method for automatically switching radio channels of a FM radio within a mobile phone having the FM radio in accordance with one embodiment.

### DETAILED DESCRIPTION OF CERTAIN INVENTIVE EMBODIMENTS

All of the processes described below may be embodied in, and fully automated via, software code modules executed by one or more general purpose processors. The code modules may be stored in any type of computer-readable medium or other computer storage device. Some or all of the methods may alternatively be embodied in specialized computer hardware.

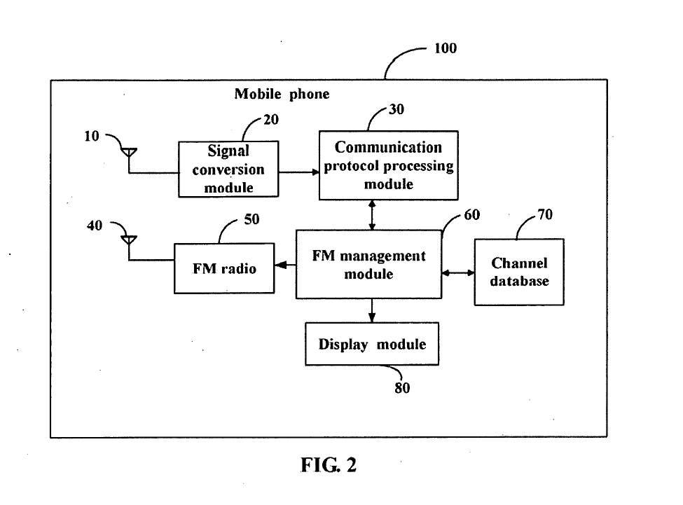

FIG. 2 is a functional block diagram of a mobile phone 100 capable of automatically switching radio channels of an FM radio 50 in accordance with one embodiment of the present disclosure. The mobile phone 100 communicates with other mobile devices via the GSM or UTMS network. In one embodiment, the mobile phone 100 comprises a first antenna 10, a signal conversion module 20, a communication protocol processing module 30, a second antenna 40, the FM radio 50, an FM management module 60, a channel database 70, and a display module 80.

The first antenna 10 receives analog signals comprising location area identity (LAI) information, broadcasted by a base transceiver station (BTS) in a local area (i.e. a city or a state) where the mobile phone 100 is located, and transferring the analog signals to the signal conversion module 20. In one embodiment, the first antenna 40 may be a GSM or a UTMS type antenna. The first antenna 10 receives the analog signals from either the GSM or UTMS networks depending on where a user is situated with the mobile phone 100. It may be understood that the mobile phone 100 may select receiving GSM or UTMS signals depending on signal strengths sent from GSM and UTMS networks. It may be understood that different local areas surrounding the mobile phone 100 has different LAI information.

The signal conversion module 20 is configured for converting the analog signals received by the first antenna 10 into digital signals, and sending the digital signals to the communication protocol processing module 30.

The communication protocol processing module 30 is configured for reading the LAI information from the digital signals sent by the signal conversion module 20, and transferring the LAI information to the FM management module 60.

The second antenna 40 receives wireless broadcast signals broadcasted by radio stations a the local area near, and transferring the wireless broadcast signals to the FM radio 50. In one embodiment, the second antenna 40 is a type of an FM antenna.

The FM radio 50 is configured for playing various kinds of radio broadcast broadcasted by the radio stations, based on the wireless broadcast signals.

The channel database 70 is configured for storing radio channel information corresponding to the LAI information of different local areas. The radio channel information comprises a radio station name, and a radio frequency band of each radio channel in the local area corresponding to each LAI.

The FM management module 60 is configured for searching the radio channel information stored in the channel database 70 according to the read LAI information, so as to retrieve radio station names of available radio channels in the area where the mobile phone 100 is located.

The display module 80 is configured for displaying the radio station names on a display of the mobile phone 100. Accordingly, the user may select an interested radio station, and then listen to radio broadcasts broadcasted by the radio station.

The FM management module 60 is further configured for monitoring if the received LAI information changes according to movement of the mobile phone 100. As mentioned above, different local areas surrounding the mobile phone 100 have different LAI information. The FM management module if further configured for determining if the selected radio station that the user is listening to is still available when the LAI information changes, which represents if the mobile phone 100 reaches a new local area. If the selected radio station is not available in the new area, the FM management module 60 retrieves radio station names of new radio channels in the new local area by searching the channel database 70, and the display module 80 displays the radio station names of available radio channels in the new local area.

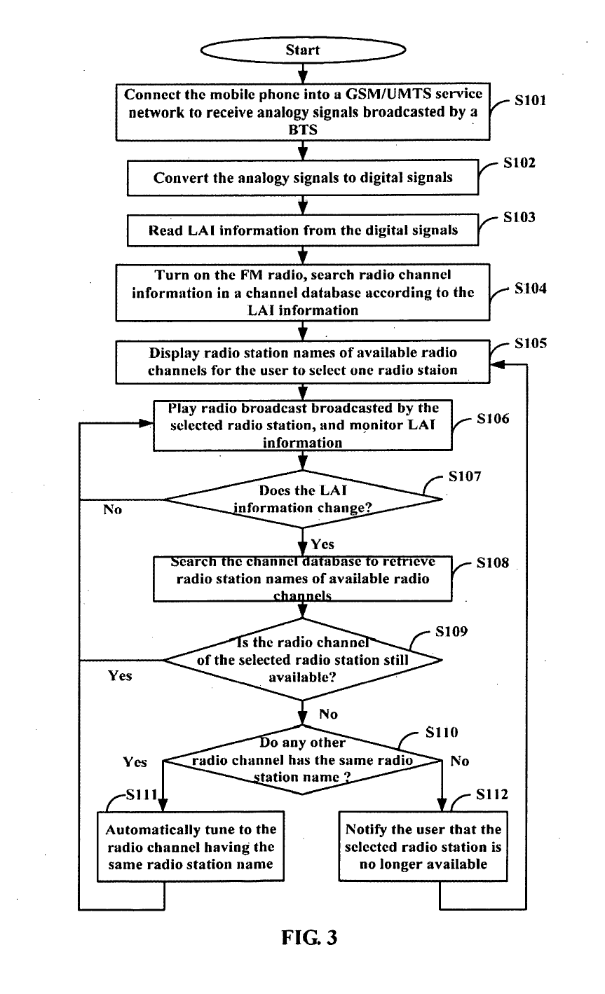

FIG. 3 is a flowchart of a method for automatically switching radio channels of a FM radio 50 within a mobile phone 100 in accordance with one embodiment of the present disclosure. Depending on the embodiment, additional blocks may be added, others removed, and the ordering of the blocks may be changed.

In block S101, the mobile phone 100 wirelessly connects either to the GSM or UMTS network in a current local area, and receives analog signals comprising LAI information, broadcasted by the BTS of the GSM or UMTS network via the first antenna 10, and transfers the analog signals to the signal conversion module 20. In block S102, the signal conversion module 20 converts the analog signals to digital signals, and transfers the digital signals to the communication protocol processing module 30. In block S103, the communication protocol processing module 30 reads the LAI information of the current area from the digital signals.

In block S104, the FM antenna 40 receives the wireless broadcast signals transmitted from various radio stations of the current local area when the user turns on the FM radio 50. Accordingly, the FM management module 60 searches the channel database 70 to retrieve radio station names of available radio channels based on the LAI information. In block S105, the display module 80 displays the radio station names of available radio channels for the user to select one radio station to listen to radio broadcast provided by the selected radio station. In block S106, the FM radio 50 plays the radio broadcast according to the wireless broadcast signals broadcasted by the selected radio station, and the FM management module 60 synchronously monitors the received LAI information.

In block S107, the FM management module 60 checks if the LAI information changes if the user moves to a new local area. If the LAI information does not change, the procedure returns to block S106. Otherwise, if the LAI information changes, in block S108, the FM management module 60 searches the channel database 70 to retrieve radio station names of available radio channels based on the changed LAI information. In block S109, the FM management module 60 checks if the radio channel of the selected radio station, which the user is listening to, is still available. If the radio channel of the selected radio station is still available, the procedure returns to block S106. Otherwise, in block S110, the FM management module 60 checks if any other radio channel having the same radio station name as the selected radio station. If there is a radio channel having the same radio station name, in block S111, the FM management module 60 automatically turns to the radio channel having the same radio station name, then the procedure goes back to block S106 as described above.

In block S110, if the FM management module 60 checks that there is no any radio channel having the same radio station name, in block S112, the FM radio management module 60 notifies the user that the selected radio station is no longer available. Then the procedure returns to block S105 as described above. Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A method for automatically switching radio channels of a frequency modulation (FM) radio within a mobile phone, the method comprising:
receiving analog signals broadcasted by a base transceiver station via a first antenna, and receiving wireless broadcast signals via a second antenna, wherein the analog signal comprises local area identity (LAI) information of a local area of where the mobile phone is located;
converting the analog signals to digital signals;
reading the LAI information from the analog signals;
searching a channel database to retrieve available radio channel information in the local area based on the LAI information;
displaying radio station names corresponding to a selected radio channel;
playing radio broadcast broadcasted by the selected radio station according to the wireless broadcast signals, and synchronously monitoring if the LAI information changes;
determining if the FM radio needs to switch the selected radio channel to an available radio channel upon the condition that the LAI information changes;
automatically switching the FM radio to the available radio channel upon the condition that the FM radio needs to switch the selected radio channel to the available radio channel; and
playing the radio broadcast based on the available radio channel.

2. The method as claimed in claim 1, wherein the determining and switching blocks comprises:
checking if the selected radio channel of the selected radio station that the user is listening to is still available;
playing the radio broadcast continuously, on condition that the selected radio channel of the selected radio station is still available;
checking if there is any other radio channel has the same radio station name as the selected radio station, on condition that the selected radio channel of the selected radio station is unavailable; and
switching the FM radio to the radio channel has the same radio station name as the selected radio station, on condition that there is a radio channel having the same radio station name.

3. The method as claimed in claim 2, wherein the determining block further comprises:
notifying the user that the selected radio station is unavailable, on condition that there is no radio channel having the same radio station name; and
going to the displaying block.

4. The method as claimed in claim 1, wherein the first antenna is a type of a UMTS antenna or a GSM antenna.

5. The method as claimed in claim 1, wherein the second antenna is a type of an FM antenna.

6. The method as claimed in claim 1, wherein the radio channel information comprises a radio station name, and a radio frequency band of each available radio channel.

7. A mobile phone capable of automatically switching radio channels, the mobile phone comprising an FM radio, the mobile phone comprising:
a first antenna for receiving analog signals;
a second antenna for receiving wireless signals;
a signal conversion module configured for converting the analog signals to digital signals;
the FM radio for playing radio broadcast according to the wireless signals;
a channel database configured for storing radio channel information corresponding to LAI information of different local areas around the mobile phone;
a communication protocol processing module configured for receiving the digital signals, and for reading the LAI information of a local area where the mobile phone is located; and
an FM management module configured for searching the channel database to retrieve available radio channel information in the local area, synchronously monitoring if the LAI information changes, and determining if the FM radio needs to switch from one radio channel to another radio channel.

8. The mobile phone as claimed in claim 7, further comprises a display module for displaying the radio station names of available radio channels for a user to select an available radio station to listen to the radio broadcast.

9. The mobile phone as claimed in claim 8, wherein the FM management module is further configured for:
checking if the radio channel of the selected radio station that the user is listening to is still available, on condition that the LAI information changes;
playing the radio broadcast upon the condition that the radio channel of the selected radio station is still available;
checking if there is any other radio channel has the same radio station name as the selected radio station upon the condition that the radio channel of the selected radio station is unavailable; and
switching the FM radio to the radio channel has the same radio station name as the selected radio station upon the condition that there is a radio channel having the same radio station name.

10. The mobile phone as claimed in claim 9, wherein the display module is further configured for notifying the user that the selected radio station is unavailable upon the condition that there is no radio channel having the same radio station name.

11. The method as claimed in claim 7, wherein the first antenna is a type of a UMTS antenna or a GSM antenna.

12. The method as claimed in claim 7, wherein the second antenna is a type of an FM antenna.

13. The method as claimed in claim 7, wherein the radio channel information comprises a radio station name, and a radio frequency band of each available radio channel.

14. A storage medium having stored thereon instructions for switching radio channels of an FM radio within a mobile device, the storage medium, when executed by the mobile device, causing the mobile device to perform blocks of:
(a) receiving analog signals broadcasted by a base transceiver station via a first antenna, and receiving wireless broadcast signals via a second antenna, wherein the analog signal comprises local area identity (LAI) information of a local area of where the mobile phone is located;
(b) converting the analog signals to digital signals;
(c) reading the LAI information from the analog signals;
(d) searching a channel database to retrieve available radio channel information in the local area based on the LAI information;
(e) displaying radio station names corresponding to a selected radio channel;
(f) playing radio broadcast broadcasted by the selected radio station according to the wireless broadcast signals, and synchronously monitoring if the LAI information changes;
(g) determining if the FM radio needs to switch the selected radio channel to an available radio channel upon the condition that the LAI information changes;
(h) automatically switching the FM radio to the available radio channel upon the condition that the FM radio needs to switch the selected radio channel to the available radio channel; and
(i) playing the radio broadcast based on the available radio channel.

15. The storage medium as claimed in claim 14, wherein the blocks (g) and (h) comprise:
checking if the selected radio channel of the selected radio station that the user is listening to is still available;
playing the radio broadcast, on condition that the selected radio channel of the selected radio station is still available;
checking if there is any other radio channel has the same radio station name as the selected radio station, on condition that the selected radio channel of the selected radio station is unavailable; and
switching the FM radio to the radio channel has the same radio station name as the selected radio station, on condition that there is a radio channel having the same radio station name.

16. The storage medium as claimed in claim 15, wherein the block (g) further comprises:
notifying the user that the selected radio station is unavailable, on condition that there is no radio channel having the same radio station name; and going to the displaying block.

17. The storage medium as claimed in claim 14, wherein the first antenna is a type of a UMTS antenna or a GSM antenna.

18. The storage medium as claimed in claim 14, wherein the second antenna is a type of an FM antenna.

19. The storage medium as claimed in claim 14, wherein the radio channel information comprises a radio station name, and a radio frequency band of each available radio channel.
